(19) United States
(12) Patent Application Publication
(10) Pub. No.: US 2010/0269730 A1
(43) Pub. Date: Oct. 28, 2010

(54) SAFETY-ENGINEERED VEHICLE

(75) Inventor: Max Horlacher, Mohlin (CH)

Correspondence Address: PEARNE & GORDON LLP, 1801 EAST 9TH STREET, SUITE 1200, CLEVELAND, OH, 44114-3108, US

(73) Assignee: GLOBAL SAFETY TEXTILES GMBH, Maulburg (DE)

(21) Appl. No.: 12/664,566

(22) PCT Filed: Jun. 10, 2008
(86) PCT No.: PCT/CH2008/000265

§ 371 Date: Jul. 13, 2010

(30) Foreign Application Priority Data
Jun. 14, 2007 (CH) 951/07

(51) Int. Cl. B61D 15/06; B60K 28/10

(52) U.S. Cl. 105/392.5; 180/274

(57) ABSTRACT

Disclosed is a vehicle, especially an automobile, comprising two external airbags for protecting persons who collide with the vehicle. A first airbag is arranged in the area of the bumper while a second airbag is located below the windshield. A triggering mechanism that is equipped with a person sensor deploys the two airbags. The risk of the colliding persons being injured is reduced as much as possible by the fact that two airbags are arranged in the front region of the vehicle and the airbags have a special shape.

The invention relates to a safety-engineered vehicle as set forth in the preamble of the independent claim 1.

To protect vehicle occupants every automobile nowadays has an interior engineered with one or more airbags. To protect pedestrians should they collide with the vehicle, it is also already known to engineer the vehicle with an external airbag. However, these known external airbags not only fail to offer adequate protection, but even pose an additional risk of injury by the pedestrian being catapulted up and away from having collided with the vehicle, to then drop back to the road surface where the injury may be even more serious than due to the collision with the vehicle.

Based on this prior art the intention of the present invention is to define a safety-engineered vehicle which reduces as best possible the risk of injury to a pedestrian having collided with the vehicle.

Achieving this object forming the basis of the invention reads from the features described in the characterizing clause of the independent claim 1. Particularly advantageous aspects and further embodiments form the subject matter of the dependent claims.

The invention will now be detailed with reference to the drawing in which:

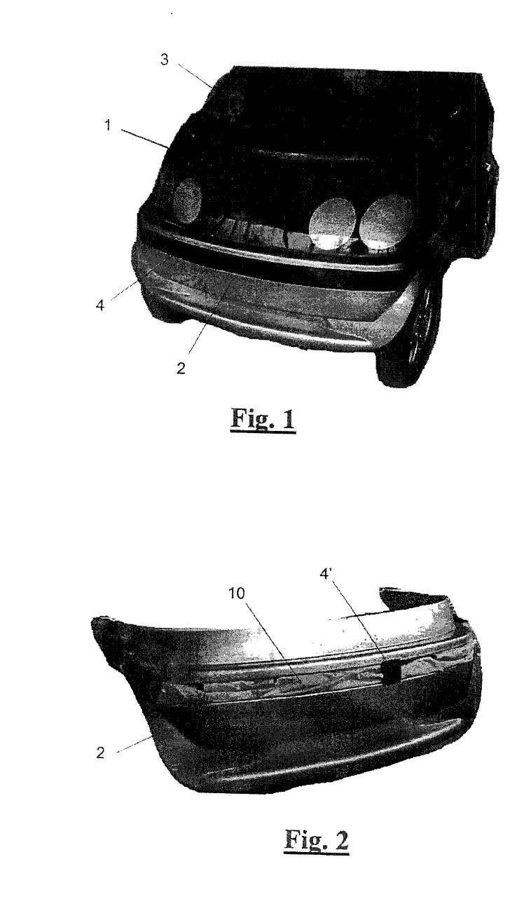

FIG. 1 is an overall view of an example aspect of the safety-engineered vehicle in accordance with the invention,

FIG. 2 is a view of the front bumper portion of the vehicle engineered with an airbag,

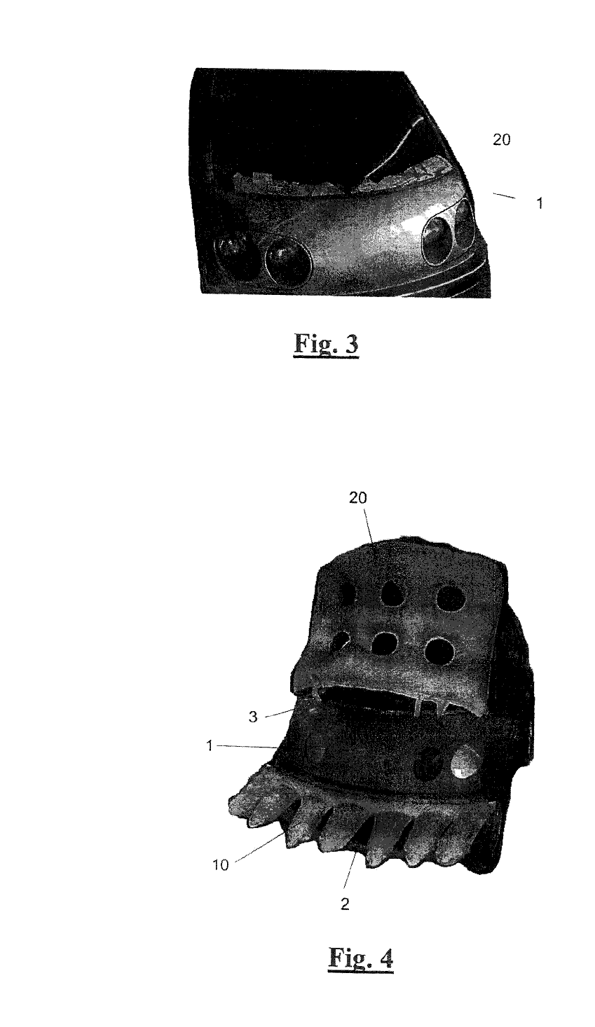

FIG. 3 is a view of the front portion of the vehicle engineered with the airbag beneath the windscreen,

FIG. 4 is a view of the vehicle engineered with two external airbags in the activated (deployed) condition,

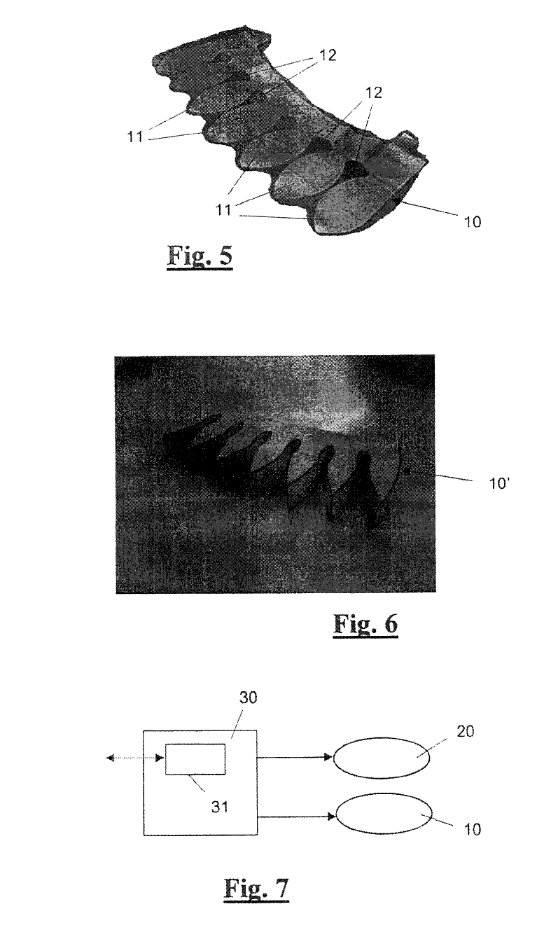

FIG. 5 is a view of a specially engineered bumper airbag,

FIG. 6 is a view of a model of a differently engineered bumper airbag, and

FIG. 7 is a diagram showing the arrangement for activating the airbag in principle.

Referring now to FIG. 1 there is illustrated the safety-engineered vehicle by way of example as an electric-powered plastics compact car in which 1 designates the front portion as a whole, 2 a generously dimensioned front bumper and 3 the windscreen.

The vehicle is engineered with two external airbags. A first airbag 10 (FIG. 2) is located in a cavity of the front bumper 2 behind a cover 4. A second airbag 20 (FIG. 3) is arranged behind the front portion 1 below the windscreen 3.

Referring now to FIG. 2 there is illustrated the front bumper 2 with the cover 4 removed, a short piece 4′ of the cover being indicated to make the relationships clear. FIG. 2 clearly depicts how the first airbag 10 is arranged folded up in the bumper.

Referring now to FIG. 3 there is illustrated how the second airbag 20 is arranged, it in practice being located folded up just below the windscreen 3 behind the front portion 1.

The two airbags 10 and 20 each feature a conventional gas generant for its activation, controlled by an activating mechanism 30, comprising sensors 31 which trigger the activating mechanism 30 in activating (deploying) the two airbags when a collision occurs (FIG. 7). In one special aspect of the invention the sensors 31 are configured to respond to personal contact by recognizing the collision as being imminent or having occurred. This prevents the airbags from being inadvertently fired e.g. in a collision with minor objects.

Referring now to FIG. 4 there is illustrated the airbags in the activated (deployed) condition, making it evident how the first airbag 10 stands out roughly horizontally from the front bumper 2 whilst the second airbag 20 lies like an air mattress before or over the windscreen 3, thus providing optimum protection of the person involved in the collision from injury.

In another important aspect of the invention the shaping of the airbag, especially of the first airbag 10 located in the bumper is emphasized. As evident from FIG. 4 the first airbag 10 when deployed features a row of substantially beveled forks 11 fronting extended from the front bumper 2. On collision with a person the forks 11 restrain the legs of the person, preventing him/her from being catapulted away.

Referring now to FIG. 5 there is illustrated how this protective effect is further enhanced by a modified shape of the airbag 10, showing the airbag deployed but not activated. It is evident how the forks 11 in this embodiment are thickened in the direction of the bumper, but becoming somewhat thinner in the vicinity of the bumper, resulting in recesses 12 being formed between the forks 11. These recesses 12 improve the restraining effect in protecting the person involved in the collision.

Referring now to FIG. 6 there is illustrated lastly a model 10′ of the bumper airbag similar to that as shown in FIG. 5, except that the airbag 10′ is not made of just two but of three or more flat blanks to provide greater spatial shaping freedom in thus further optimizing the restraining effect of the forks.

It will be appreciated that the engineered safety feature discussed above in conjunction with an automobile can be put to use just as well on other vehicles, for instance, on a streetcar or on rail vehicles in general.

1. A safety-engineered vehicle comprising at least one external airbag, characterized in that a first airbag (10) is arranged in the region of the front bumper (2) of the vehicle featuring when deployed a forked comb-like configuration with forks (11) fronting the bumper.

2. The vehicle as set forth in claim 1, characterized in that recesses (12) are configured between the forks (11) of the first airbag (10) in the vicinity of the bumper so that the spacings of the forks (11) in the vicinity of the bumper are larger than further away from the bumper.

3. The vehicle as set forth in any of the preceding claims, characterized in that arranged below the windscreen (3) of the vehicle is a second airbag (20) which when activated covers the windscreen.

4-5. (canceled)

6. The vehicle as set forth in claim 1 or 2, characterized in that it is a rail vehicle.

7. The vehicle as set forth in claim 6, characterized in that it is a streetcar.

8. The vehicle as set forth in claim 3, characterized in that it is a rail vehicle.
